(19) United States
(12) Patent Application Publication
(10) Pub. No.: US 2026/0360040 A1
(43) Pub. Date: Nov. 12, 2026

(54) IMAGE DECODING APPARATUS, IMAGE CODING APPARATUS, IMAGE DECODING METHOD, AND IMAGE CODING METHOD

(71) Applicant: Sharp Kabushiki Kaisha, Sakai City, Osaka (JP)

(72) Inventors: Takeshi CHUJOH, Sakai City (JP); Tomohiro IKAI, Sakai City (JP); Tomoko AONO, Sakai City (JP); Yukinobu YASUGI, Sakai City (JP); Zheming FAN, Sakai City (JP); Sujun HONG, Sakai City (JP); Hiroshi WATANABE, Tokyo (JP)

(21) Appl. No.: 19/515,874

(22) PCT Filed: Sep. 3, 2024
(86) PCT No.: PCT/JP2024/031532

§ 371 Date: Mar. 3, 2026

(30) Foreign Application Priority Data
Sep. 7, 2023 (JP) 2023-144898

(51) Int. Cl. G06T 11/60; G06T 9/00; G06T 9/20

(52) U.S. Cl. CPC G06T 11/60; G06T 9/002; G06T 9/20

(57) ABSTRACT

The image generation neural network enables generation of various images with a small amount of text information, but it is difficult to perform fine control such as bringing an image close to a specific image. Furthermore, although the generated image can be controlled to some extent by using a supplemental condition input, the relationship between the amount of information to be input and the quality of the generated image is not controlled, and there is a problem that it is difficult to apply the method to image coding and decoding. An image decoding apparatus (30) according to an aspect of the present invention includes a generative information decoding apparatus (302) configured to decode coded data to create generative information, and an image generation neural network apparatus (301) configured to generate a decoded image from the generative information.

### TECHNICAL FIELD

Embodiments of the present invention relate to an image coding apparatus and a decoding apparatus.

### BACKGROUND ART

An image coding apparatus which generates coded data by coding images and an image decoding apparatus which generates decoded images by decoding the coded data are used to transmit and record images efficiently.

Specific image coding schemes include, for example, the H.266/Versatile Video Coding (VVC) scheme and the like.

In such traditional image coding schemes, an image is divided to be coded/decoded. First, a prediction image is generated based on a locally decoded image obtained by coding input image/decoding coded data. Next, a prediction error obtained by subtracting the prediction image from the input image (original image) (which may be referred to as a “difference image” or a “residual image”) is coded/decoded.

Meanwhile, in Non Patent Literature 1, published recently, as an image generation method using a neural network, a method using a diffusion model, which is referred to as Stable Diffusion, is disclosed. In the method, an image can be generated based on text input by a user, which is referred to as a prompt.

Further, Non Patent Literature 2 discloses a scheme of controlling a neural network using a supplemental input condition in addition to a prompt called ControlNet for Stable Diffusion, and generating an image. This enables condition input of an edge map, a segmentation map, a key point, and the like.

### CITATION LIST

### Non Patent Literature

Non Patent Literature 1: R. Rombach, A. Blattmann, D. Lorenz, P. Esser and B. Ommer, “High-Resolution Image Synthesis with Latent Diffusion Models,” Computer Vision and Pattern Recognition (CVPR) 2022.
Non Patent Literature 2: L. Zhang and M. Agrawala, “Adding Conditional Control to Text-to-Image Diffusion Models,” arXiv: 2302.05543, Feb. 2023.

### SUMMARY OF INVENTION

### Technical Problem

The method disclosed in Non Patent Literature 1 enables generation of various images with a small amount of text information, but has a problem in that it is difficult to perform fine control such as bringing an image close to a specific image. Therefore, it is difficult to apply this method to image coding and decoding.

In the method disclosed in Non Patent Literature 2, although the generated image can be controlled to some extent by using a supplemental condition input, the relationship between the amount of information to be input and the quality of the generated image is not controlled, and it is difficult to apply the method to image coding and decoding.

### Solution to Problem

An image decoding apparatus according to an aspect of the present invention includes a generative information decoding apparatus configured to decode coded data to create generative information, and an image generation neural network apparatus configured to generate a decoded image from the generative information.

An image coding apparatus according to an aspect of the present invention includes: a generative information creation apparatus configured to create generative information for image generation; an image generation neural network apparatus configured to generate an image from the generative information; a generative information coding apparatus configured to code the generative information; and a coding control apparatus configured to calculate a cost value from a result of comparing an image generation result of the image generation neural network apparatus and an input image signal, and a code amount from the generative information coding apparatus, and feeds back a result to the generative information creation apparatus.

### Advantageous Effects of Invention

Employing the configuration as described above can solve a problem of achieving fine control of coding and decoding of an image with an extremely small code amount by using an image generation neural network.

### BRIEF DESCRIPTION OF DRAWINGS

FIG. 1 is a schematic diagram illustrating a configuration of an image transmission system according to the present embodiment.

FIG. 2 is a diagram illustrating an example of a configuration of a generative information coding apparatus and a generative information decoding apparatus.

FIG. 3 is a diagram illustrating an example of syntax of image information.

FIG. 4 is a diagram illustrating an example of syntax of text information.

FIG. 5 is a diagram illustrating an example of syntax of seed information.

FIG. 6 is a diagram illustrating an example of syntax of hint information.

FIG. 7 is a diagram illustrating another configuration of a generative information coding apparatus and a generative information decoding apparatus.

FIG. 8 is a diagram illustrating an example of syntax of image generation network information.

FIG. 9 is a schematic diagram illustrating a configuration of another image transmission system according to the present embodiment.

FIG. 10 is a schematic diagram illustrating a configuration of another image transmission system according to the present embodiment.

FIG. 11 is a diagram illustrating an example of syntax in a case of synthesizing a plurality of generated images.

### DESCRIPTION OF EMBODIMENTS

### First Embodiment

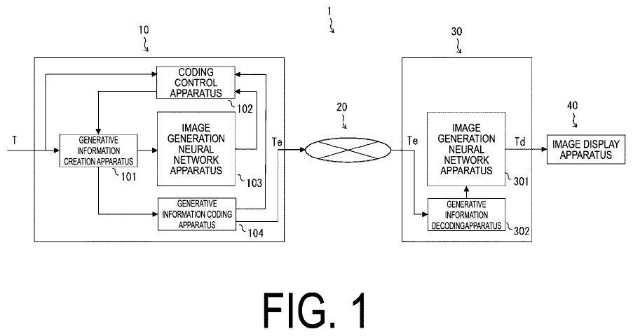

FIG. 1 is a conceptual diagram illustrating a configuration of an image transmission system according to the present embodiment.

An image transmission system 1 includes an image coding apparatus 10, a transmission network 20, an image decoding apparatus 30, and an image display apparatus 40.

The image coding apparatus 10 receives an input of an image signal T, and outputs coded data Te.

The transmission network 20 transmits the coded data Te from the image coding apparatus 10 to the image decoding apparatus 30. The transmission network 20 is the Internet, a Wide Area Network (WAN), a Local Area Network (LAN), or a combination thereof. The network 20 is not limited to a bi-directional communication network and may be a unidirectional communication network that transmits broadcast waves for terrestrial digital broadcasting, satellite broadcasting, or the like. The transmission network 20 may be substituted with a storage medium in which the coded data Te is recorded, such as a Digital Versatile Disc (DVD) (trade name) or a Blue-ray Disc (BD) (trade name).

The image decoding apparatus 30 receives an input of the coded data Te, outputs a decoded image Td, and sends the decoded image Td to the image display apparatus 40.

The image display apparatus 40 displays all or part of the decoded image Td output from the image decoding apparatus 30. For example, the image display apparatus 40 includes a display device such as a liquid crystal display and an organic Electro-luminescence (EL) display. Examples of display types include stationary, mobile, and HMD. In addition, in a case that the image decoding apparatus 30 has a high processing capability, an image having high image quality is displayed, and in a case that the apparatus has a lower processing capability, an image which does not require a high processing capability and display capability is displayed.

The image coding apparatus 10 includes a generative information creation apparatus 101, a coding control apparatus 102, an image generation neural network apparatus 103, and a generative information coding apparatus 104.

The generative information creation apparatus 101 receives the image signal T and a control signal from the coding control apparatus 102, creates generative information for image generation, and outputs the generative information to the image generation neural net apparatus 103 and the generative information coding apparatus 104.

The image generation neural network apparatus 103 generates an image based on the generative information created by the generative information creation apparatus 101, and sends the image generation result to the coding control apparatus 102.

The generative information coding apparatus 104 codes the generative information and creates the coded data Te, and sends the code amount to the coding control apparatus 102.

The coding control apparatus 102 calculates a cost value from a comparison result between the image generation result of the image generation neural network apparatus 103 and the input image signal T and the code amount from the generative information coding apparatus 104, and feeds back the result (control signal) to the generative information creation apparatus 101.

The image generation neural network apparatus 103 compares the image generation result and the input image signal T using an evaluation criterion D of image similarity, such as a mean squared error, an absolute value error sum, Structural Similarity (SSIM), Multi-Scale Structural Similarity (MS-SSIM), and Learned Perceptual Image Patch Similarity (LPIPS). The cost value is calculated using an equation cost C=D+λR, where, for example, λ is an undetermined constant of the Lagrange's undetermined multiplier method, D is the evaluation criterion, and R is a code amount of generative information.

The image decoding apparatus 30 includes an image generation neural network apparatus 301 and a generative information decoding apparatus 302.

The generative information decoding apparatus 302 decodes the coded data Te based on the syntax, and sends the decoded generative information to the image generation neural network apparatus 301.

The image generation neural network 301 generates the decoded image Td based on the generative information decoded by the generative information decoding apparatus 302, and sends the decoded image Td to the image display apparatus 40. The image generation neural network 103 and the image generation neural network 301 perform the same operation.

The generative information creation apparatus 101 generates information for the image generation neural network apparatus 103 to generate an image. Specifically, generative information includes at least text information, seed information, and hint information. Text information is information for describing the content of an image to be generated. Seed information is a control-related parameter to be input to the generated image neural network.

Hint information is contour information or the like of an image that is a hint of a generated image. The hint information may have hint information fidelity indicating the degree of the hint information.

Specifically, image information indicates the following information of the image signals generated by the image generation neural network apparatuses 103 and 301.
Chroma format of generated image (4:2:0, 4:2:2, 4:4:4)
Number of pixels in horizontal direction and vertical direction of generated image
Bit-depth of pixels of generated image
Alpha map (transparency information) of generated image
Offset values in up, down, left, and right directions of a generated image for deriving a cropped image to be output to the image display apparatus 40
Image signal information described as a video usability information (VUI) parameter (content defined by Recommendation ITU-T H.274|ISO/IEC 23002-7), and the like.

Text information is information expressed by a combination of words or text input to the image generation neural network apparatuses 103 and 301. The word is called a prompt and a negative prompt. The prompt is an expression that is related to the content of the generated image, whereas the negative prompt indicates an expression that is not present in the content of the generated image.

Seed information (parameter information) is control-related information to be input to the image generation neural network apparatuses 103 and 301. Specifically, the following is included.
Initial value of seed (random number seed)
Fidelity information of the prompt (e.g., CFG scale, Classifier Free Guidance scale)
Information of type of scaler
Scaler iteration (steps) information, and the like.

In addition to the above, a parameter that can control the generated image of the image generation neural network apparatuses 103 and 301 can be used as seed information. Seed information (parameter information) may be a scalar value, or a set of scalar values in a case where there are a plurality of pieces of seed information.

Initial value of seed information is a value of a seed for generating an initial image of a random number to be input to the image generation neural network apparatuses 103 and 301. The same scheme is shared by the image coding apparatus 10 and the image decoding apparatus 30 as a method of generating a random number.

Fidelity information is a value indicating the degree to which the prompt is applied, and the larger the value, the stronger the constraint condition using the prompt is given. Although a real value of 4 to 14 may be used, CFG scale information that is an integer in a prescribed range (e.g., 0 to 127) may be transmitted, and a value obtained by dividing the CFG scale information by a prescribed number (e.g., 8 or 10) may be input to the neural network.

The sampling method type information indicates the type of noise removal (scaler) algorithm applied to the diffusion model. Note that in a case that the GAN model is used without using the diffusion model, the steps information is not necessary and thus coding and decoding is not performed.

The sampling iteration number (steps) information indicates the number of times of application of noise removal by the diffusion model, and is a parameter for determining how finely an image is drawn.

Hint information is extension information that is a hint for image generation to be input to the image generation neural network apparatuses 103 and 301. Specifically, the method includes any of the following.
Image contour information
Reduced image information (thumbnail information, rough image information)
Image skeleton (pose) information (posture information)
Color information for each region of image (segmentation image information)
Color histogram information of image
Alpha map of image (transparency information)
Depth map (depth information) of image

In addition to the above, data that can control the generated image of the image generation neural network apparatuses 103 and 301 can be used as hint information.

Specifically, image contour information may be a monochrome image obtained by performing contour extraction processing on the image signal T. It may be binary or multi-level. Moreover, the number of pixels in the horizontal direction and the vertical direction of the original image signal T may be reduced to reduce the size thereof.

Specifically, reduced image information is an image obtained by performing reduction processing on the image signal T to reduce the number of pixels in the horizontal direction and the vertical direction. For example, the images may be images of 240×35, 120×68, and 60×34 obtained by reducing 4K into ⅛, 1/16, 1/32, and 1/64. Alternatively, the image may be a square image such as a 64×64 or a 128×128.

Specifically, image skeleton information is an image including skeleton information representing a pose of a person or the like.

Region color information of an image is an image obtained by performing region (segmentation) separation processing on the image signal T and expressing each region by a color approximate to the image signal T.

Color histogram information of an image is data indicating the frequency of pixels of the image.

An alpha map of an image is a value representing the transparency of pixels of the image, and is information in which the smaller the value, the higher the transparency, and the larger the value, the higher the opacity.

A depth map of an image is information representing the depth of the image from the screen, and is information indicating that the smaller the value is, the farther the image is, and the larger the value is, the closer the image is.

The image contour information, the reduced image information, the image skeleton information, and the region color information may be coded by a still-image compression scheme such as PNG, JPEG, WebP, HEVC (HEIF), AVIF, or JPEG-XL. The hint information is coded and decoded by a hint information coder 1044 and a hint information decoder 3024, which will be described later.

The generative information creation apparatus 101 changes the generative information based on the cost value fed back from the coding control apparatus 102 to change the generative information. The image generation neural network apparatus 103 generates an image based on the changed generative information and sends the image to the coding control apparatus 102. The generative information coding apparatus 104 codes the changed generative information and sends the code amount to the coding control apparatus 102. The coding control apparatus 102 may calculate the cost value and update the generative information until the cost value becomes sufficiently small. The above processing is repeated until an image generation result corresponding to the code amount of the generative information is obtained.

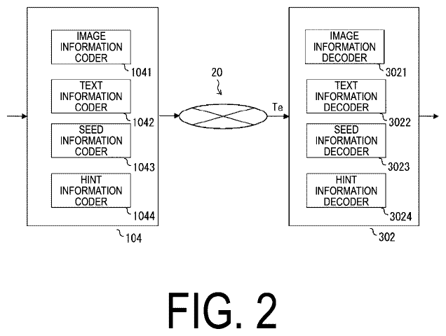

FIG. 2 is a diagram illustrating an example of the generative information coding apparatus 104 and the generative information decoding apparatus 302 of the present embodiment. The generative information coding apparatus 104 includes an image information coder 1041, a text information coder 1042, a seed information coder 1043, and the hint information coder 1044. The generative information decoding apparatus 302 includes an image information decoder 3021, a text information decoder 3022, a seed information decoder 3023, and the hint information decoder 3024.

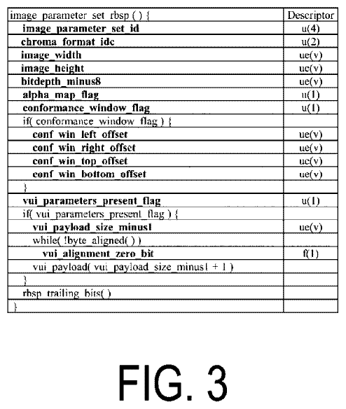

As an example of an embodiment of the image information coder 1041 and the image information decoder 3021, the syntax is illustrated in FIG. 3.
image_parameter_set_rbsp( ) is a syntax table of a raw byte sequence payload (RBSP) structure, and is coded data including an integer number of bytes encapsulated in the NAL unit.

Note that the meaning of a notation of “Descriptor” in the following syntax tables is interpreted as follows.
b(8): indicates a value of a byte having any pattern of a bit string (8 bits).
f(n): indicates a bit character string having a fixed pattern using n bits written sequentially from the left bit (from left to right).
se(v): indicates a syntax element obtained by performing 0-order Exp-Golomb coding on a signed integer.
st(v): indicates a character string coded by UTF-8 and terminated with null.
u(n): indicates an unsigned integer using n bits. In a case that n is “v” in the syntax table, the number of bits varies depending on values of other syntax elements.
ue(v): indicates a syntax element obtained by performing 0-order Exp-Golomb coding on an unsigned integer (left bit first).

The syntax element image_parameter_set_id indicates an identification value for reference by another syntax element. The generative information for the same generated image has the same value.

The syntax element chroma_format_idc represents the chroma format. In a case that the value of chroma_format_idc is 0, that is, in a case of monochrome format, the values of a variable SubWidthC and a variable SubHeightC are both 1. In a case that the value of chroma_format_idc is 1, that is, in the case of 4:2:0 format, the values of the variable SubWidthC and the variable SubHeightC are both 2. In a case that the value of chroma_format_idc is 2, that is, in the case of 4:2:2 format, the value of the variable Sub WidthC is 2 and the value of the variable SubHeightC is 1. In a case that the value of chroma_format_idc is 3, that is, in the case of 4:4:4 format, the values of the variable Sub WidthC and the variable SubHeightC are both 1. Note that in the case of RGB data, the value of chroma_format_idc is 3, and the luminance Y and the chrominance Cb and the chrominance Cr of the 4:4:4 format are assigned in the order of GBR.

The syntax element image_width represents the number of pixels in the horizontal direction of the luminance of the generated image.

The syntax element image_height represents the number of pixels in the vertical direction of the luminance of the generated image.

A value obtained by adding 8 to the syntax element bitdepth_minus8 indicates the pixel bit-depth of the generated image.

The syntax element alpha_map_flag is a flag indicating whether or not the generated image has an alpha map (information of transparency) of a pixel value, and in a case that the value is 1, an alpha map having the same numbers of pixels in the horizontal direction and the vertical direction as the luminance of the generated image and the same pixel bit-depth as the generated image is present. In a case that the value is 0, there is no alpha map. In a case that the alpha map is used as a real value from 0 to 1, a value obtained by dividing the pixel value of the alpha map by (1<<(bitdepth_minus8+8))−1 is used.

The syntax element conformance_window_flag is a flag that is set to 1 in a case that the generated image output by the image generation neural network apparatus 301 is cropped by cropping the top, bottom, left, and right portions of the generated image and output to the image display apparatus 40. In a case that the value of conformance_window_flag is 0, the generated image output by the image generation neural network apparatus 301 is output to the image display apparatus 40 as it is.

In a case that the value of conformance_window_flag is 1, the syntax elements conf_win_left_offset, conf_win_right_offset, conf_win_top_offset, conf_win_bottom_offset are coded and decoded. In a case that the value of conformance_window_flag is 0, the syntax elements conf_win_left_offset, conf_win_right_offset, conf_win_top_offset, conf_win_bottom_offset are not coded or decoded, and the values are all set equal to 0.

A generated image sent to the image display apparatus 40 includes pixels of a luminance in which the horizontal image coordinates range from SubWidthC * conf_win_left_offset to image_width-(SubWidthC * conf_win_right_offset+1) and the vertical image coordinates range from SubHeightC * conf_win_top_offset to image_height-(SubHeightC * conf_win_bottom_offset+1).

Note that the value of SubWidthC * (conf_win_left_offset+conf_win_right_offset) must be less than image_width, and the value of SubHeightC * (win_top_offset+conf_win_bottom_offset) must be less than image_height.

In a case that the value of the syntax element vui_parameters_present_flag is equal to 1, it indicates that vui_payload( ) of the VUI parameter is coded and decoded. In a case that the value of vui_parameters_present_flag is equal to 0, the VUI parameters are considered to not be present in the image information, to be unspecified, or to have been determined by external means by an application.

A value obtained by adding 1 to the syntax element vui_payload_size_minus1 indicates the number of bytes in the vui_payload( ) syntax structure. Note that the value of vui_payload_size_minus1 must be in the range of 0 to 1023, inclusive.

byte_aliged( ) is a function that returns whether the current coded data is in bytes, and in a case of not being in bytes, the position of bits is adjusted by inserting a syntax element vui_alignment_zero_bit. The value of vui_alignment_zero_bit is always equal to 0.

In vui_payload( ), the VUI parameter is coded and decoded as information of the number of bytes of vui_payload_size_minus1 plus 1.

rbsp_trailing_bits( ) is a stuffing bit of 1 bit or more and 8 bits or less inserted so that the coded data of the RBSP structure is in byte units.

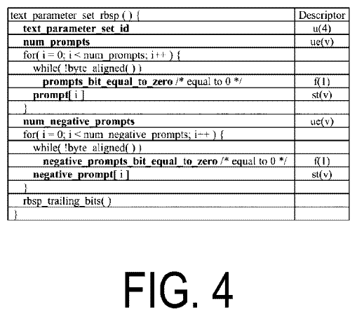

As an example of an embodiment of the text information coder 1042 and the text information decoder 3022, the syntax of FIG. 4 is illustrated.

text_parameter_set_rbsp( ) is a syntax table of a raw byte sequence payload (RBSP) structure, and is coded data including an integer number of bytes encapsulated in the NAL unit.

The syntax element text_parameter_set_id indicates an identification value for reference by another syntax element. The generative information for the same generated image has the same value.

The syntax element num_prompts represents the number of prompts.

byte_aliged( ) is a function that returns whether the current coded data is in bytes, and in a case of not being in bytes, the position of bits is adjusted by inserting a syntax element prompts_bit_equal_to_zero. The value of prompts_bit_equal_to_zero is always equal to 0.

The syntax element prompt [i] indicates the string of the i-th prompt. A prompt is a word or a sentence representing the content of the generated image, and is a part of the generative information to the generated image neural network apparatuses 103 and 301.

The syntax element num_negative_prompts represents the number of negative prompts.

byte_aliged( ) is a function that returns whether the current coded data is in bytes, and in a case of not being in bytes, the position of bits is adjusted by inserting a syntax element negative_prompts_bit_equal_to_zero. The value of negative_rompts_bit_equal_to_zero is always equal to 0.

The syntax element negative_prompt [i] indicates the string of the i-th negative prompt. A negative prompt is a word or a sentence representing a content not present in the generated image, and is a part of the generative information to the generated image neural network apparatuses 103 and 301.

rbsp_trailing_bits( ) is a stuffing bit of 1 bit or more and 8 bits or less inserted so that the coded data of the RBSP structure is in byte units.

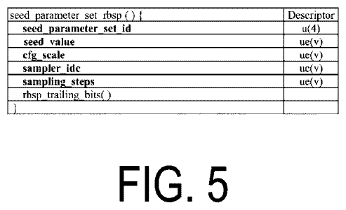

As an example of an embodiment of the seed information coder 1043 and the seed information decoder 3023, the syntax of FIG. 5 is illustrated. seed_parameter_set_rbsp( ) is a syntax table of a raw byte sequence payload (RBSP) structure, and is coded data including an integer number of bytes encapsulated in the NAL unit.

Note that the negative prompt may be included in the prompt without separating the prompt into the prompt and the negative prompt. In this case, the negative prompt is not coded and decoded, and only the prompt is coded and decoded. Alternatively, the number of prompts need not be decoded, and the prompt may be separated with a delimiter (e.g., a space) to be coded and decoded as one sentence.

The syntax element seed_parameter_set_id indicates an identification value for reference by another syntax element. The generative information for the same generated image has the same value.

The syntax element seed_value is an integer value greater than or equal to 0.

The syntax element cfg_scale indicates the fidelity of the prompt and is an integer value greater than or equal to zero. In the case of expressing the value by a real number, the value may be expressed by an integer multiplied by 10, and the value of cfg_scale may be divided by 10. Note that prompt_fidelity_value (fidelity of a prompt) may be used instead of cfg_scale.

The syntax element sampler_idc is an integer value greater than or equal to 0. In particular, the values 0, 1, 2, 3, 4, 5, 6, and 7 are index values indicating the types of scalers, such as Denoising Diffusion Implicit Models (DDIM), PLMS, LMS, Heun, DPM2, DPM2 a, Euler, and Euler a, respectively. Note that the sampling method may be a method other than these methods, or may be added.

The syntax element sampler_steps is an integer value greater than or equal to 0.

rbsp_trailing_bits( ) is a stuffing bit of 1 bit or more and 8 bits or less inserted so that the coded data of the RBSP structure is in byte units.

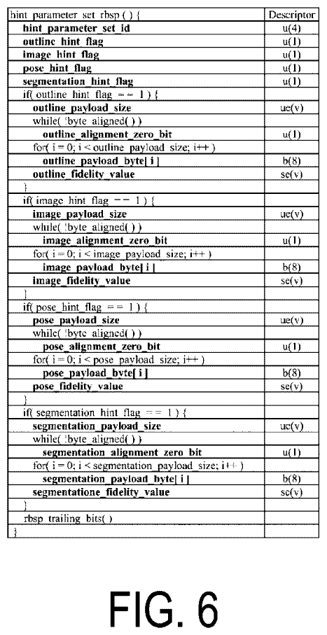

As an example of an embodiment of the hint information coder 1044 and the hint information decoder 3024, the syntax of FIG. 6 is illustrated.

hint_parameter_set_rbsp( ) is a syntax table of a raw byte sequence payload (RBSP) structure, and is coded data including an integer number of bytes encapsulated in the NAL unit.

The syntax element hint_parameter_set_id indicates an identification value for reference by another syntax element. The generative information for the same generated image has the same value.

The syntax element outline_hint_flag is a flag indicating that image contour information is present, and in a case that the value is 1, coded image contour information is present. In a case that the value of outline_hint_flag is 0, the image contour information does not exist.

The syntax element image_hint_flag is a flag indicating that reduced image information is present, and in a case that the value is 1, coded reduced image information is present. In a case that the value of image_hint_flag is 0, the reduced image information does not exist.

The syntax element pose_hint_flag is a flag indicating that image skeleton information is present, and in a case that the value is 1, coded image skeleton information is present. In a case that the value of pose_hint_flag is 0, the image skeleton information does not exist.

The syntax element segmentation_hint_flag is a flag indicating that image region color information is present, and in a case that the value is 1, coded image region color information is present. In a case that the value of segmentation_hint_flag is 0, the image region color information does not exist.

In a case that the value of outline_hint_flag is 1, image contour information is present, and the syntax element outline_payload_size is coded and decoded. outline_payload_size indicates the number of bytes of outline_payload_byte.

byte_aliged( ) is a function that returns whether the current coded data is in bytes, and in a case of not being in bytes, the position of bits is adjusted by inserting a syntax element outline_alignment_zero_bit. The value of outline_alignment_zero_bit is always equal to 0.

outline_payload_byte [i] is coded and decoded as coded data of image contour information of the number of bytes of outline_payload_size.

The hint information coder 1044 codes the image contour information by an existing image coding scheme, such as JPEG (ITU-T T. 81|ISO/IEC 109181-1), JPEG2000 (ITU-T T. 800|ISO/IEC 15444-1), AVC (ITU-T H. 264|ISO/IEC 14496-10), HEVC (ITU-T H. 265|ISO/IEC 23008-2), VVC (ITU-T H. 266|ISO/IEC 23090-3), PNG (Portable Network Graphics, ISO/IEC 15948), or the like, and the hint information decoder 3024 decodes the coded image contour information.

The syntax element outline_fidelity_value is an integer value representing the fidelity of the image contour information.

In a case that the value of image_hint_flag is 1, reduced image information is present, and the syntax element image_payload_size is coded and decoded. image_payload_size indicates the number of bytes of image_payload_byte.

byte_aliged( ) is a function that returns whether the current coded data is in bytes, and in a case of not being in bytes, the position of bits is adjusted by inserting a syntax element image_alignment_zero_bit. The value of image_alignment_zero_bit is always equal to 0.

image_payload_byte [i] is coded and decoded as coded data of reduced image information of the number of bytes of image_payload_size.

The hint information coder 1044 codes the reduced image information by an existing image coding scheme, such as JPEG, JPEG2000, AVC, HEVC, VVC, PNG, or the like, and the hint information decoder 3024 decodes the coded information.

The syntax element image_fidelity_value is an integer value representing the fidelity of the reduced image information.

In a case that the value of pose_hint_flag is 1, image skeleton information is present, and the syntax element pose_payload_size is coded and decoded. pose_payload_size indicates the number of bytes of pose_payload_byte.

byte_aliged( ) is a function that returns whether the current coded data is in bytes, and in a case of not being in bytes, the position of bits is adjusted by inserting a syntax element pose_alignment_zero_bit. The value of pose_alignment_zero_bit is always equal to 0.

pose_payload_byte [i] is coded and decoded as coded data of image skeleton information of the number of bytes of pose_payload_size.

The hint information coder 1044 codes the image skeleton information by an existing image coding scheme, such as JPEG, JPEG2000, AVC, HEVC, VVC, PNG, or the like, and the hint information decoder 3024 decodes the coded information.

The syntax element pose_fidelity_value is an integer value representing the fidelity of the image skeleton information.

In a case that the value of segmentation_hint_flag is 1, image region color information is present, and the syntax element segmentation_payload_size is coded and decoded. segmentation_payload_size indicates the number of bytes of segmentation_payload_byte.

byte_aliged( ) is a function that returns whether the current coded data is in bytes, and in a case of not being in bytes, the position of bits is adjusted by inserting a syntax element segmentation_alignment_zero_bit. The value of segmentation_alignment_zero_bit is always equal to 0.

segmentation_payload_byte [i] is coded and decoded as coded data of image region color information of the number of bytes of segmentation_payload_size.

The hint information coder 1044 codes the image region color information by an existing image coding scheme, such as JPEG, JPEG2000, AVC, HEVC, VVC, PNG, or the like, and the hint information decoder 3024 decodes the coded information.

The syntax element segmentation_fidelity_value is an integer value representing the fidelity of the image region color information.

Although not illustrated, the syntax element colour_hint_flag is a flag indicating that color histogram information is present, and in a case that the value is 1, color histogram information is present. In a case that the value of colour_hint_flag is 0, the image region color information does not exist. In a case that colour_hint_flag=1, colour_histgram_val [i] (e.g. i=0 . . . 255) is coded and decoded in ue (v). colour_histgram_val indicates the frequency of a color (e.g., luminance) in a case that the pixel bit-depth of 0 to 255 of the generated image is indicated by 8 bits, for example. Furthermore, the color may be indicated by the frequency of RGB or YUV, and may be colour_histgram_val [cldx] [i] (e.g., cIdx=0 . . . 2, i=0 . . . 255). The color range is not limited to 0 to 255, and may be a rough color range such as 0 . . . 15. In addition, since adjacent histogram values are often close to each other, colour_histgram_val may be a difference value (difference histogram value) between adjacent histogram values. In this case, the histogram value is derived from the immediately preceding histogram value and the transmitted difference histogram value.

rbsp_trailing_bits( ) is a stuffing bit of 1 bit or more and 8 bits or less inserted so that the coded data of the RBSP structure is in byte units.

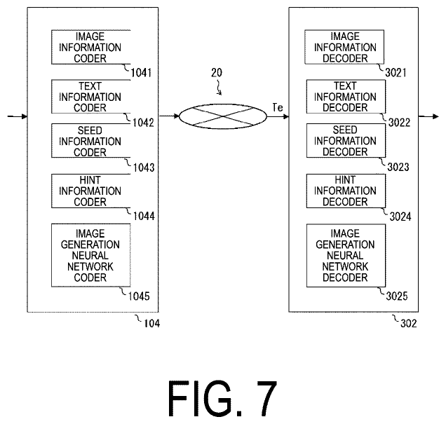

FIG. 7 is a diagram illustrating another example of the generative information coding apparatus 104 and the generative information decoding apparatus 302 of the present embodiment. The generative information coding apparatus 104 includes the image information coder 1041, the text information coder 1042, the seed information coder 1043, the hint information coder 1044, and an image generation neural network coder 1045. The generative information decoding apparatus 302 includes the image information decoder 3021, the text information decoder 3022, the seed information decoder 3023, the hint information decoder 3024, and an image generation neural network decoder 3025.

The difference from the configuration of FIG. 2 is that the image generation network itself is coded by the image generation neural network coder 1045, sent from the image coding apparatus 10 to the image decoding apparatus 30, and decoded by the image generation neural network decoder 3025. This enables the image generation neural network apparatuses 103 and 301 to be dynamically changed.

The image generation neural network coder 1045 and the image generation neural network decoder 3025 code and decode the image generation neural network entirely or partially using a method such as NNC (Neural Network Coding/ISO/IEC 15938-17).

In addition, as the image generation neural network coder 1045 and the image generation neural network decoder 3025, a plurality of sets of the same image generation neural network apparatuses 103 and 301 are prepared in the image coding apparatus 10 and the image decoding apparatus 30. Index values indicating the plurality of sets of image generation network apparatuses may be coded and decoded.

The image generation neural network coder 1045 codes a uniform resource identifier (URI) indicating the image generation neural network apparatus, and the image generation neural network decoder 3025 decodes the URI. The image decoding apparatus 30 identifies the image generation neural network apparatus 301 from the URI.

Specifically, a plurality of sets of the same image generation neural network apparatuses 103 and 301 are prepared in the image coding apparatus 10 and the image decoding apparatus 30, and a URI is used as an index value indicating the image generation network apparatuses of the plurality of sets.

In addition, as another example, the image generation neural network apparatus may be downloaded and used by each of the image coding apparatus 10 and the image decoding apparatus 30 as data coded by NNC or the like from an external website indicated by a URI.

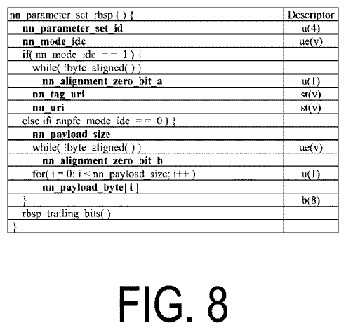

As an example of an embodiment of the image generation neural network coder 1045 and the image generation neural network decoder 3025, the syntax of FIG. 8 is illustrated.

nn_parameter_set_rbsp( ) is a syntax table of a raw byte sequence payload (RBSP) structure, and is coded data including an integer number of bytes encapsulated in the NAL unit.

The syntax element nn_parameter_set_id indicates an identification value for reference by another syntax element. The generative information for the same generated image has the same value.

The syntax element nn_mode_idc is a value indicating in what form the image generation network information is coded and decoded. In a case that the value is 1, it indicates that the image generation network information is identified by a URI, and in a case that the value is 0, it indicates that the image generation network information is coded and decoded by NNC.

In a case that the value of nn_mode_idc is 1, there is a URI that identifies the image generation neural network information.

byte_aliged( ) is a function that returns whether the current coded data is in bytes, and in a case of not being in bytes, the position of bits is adjusted by inserting a syntax element nn_alignment_zero_bit_a. The value of nn_alignment_zero_bit_a is always equal to 0.

The syntax element nn_tag_uri includes a tag URI having syntax and semantics specified in IETF RFC 4151, and identifies the format and associated information for the image generation neural network to be used. In a case that nn_tag_uri is equal to “tag: iso. org, 2023:15938-17”, it indicates that the coded data of the image generation neural network identified by nn_uri conforms to NNC (ISO/IEC 15938-17).

The syntax element nn_uri includes a URI having syntax and semantics specified in IETF Internet Standard 66, and can identify the image generation neural network to be used.

In a case that the value of nn_mode_idc is 0, it is indicated that the image generation network information is coded and decoded by NNC, and the syntax element nn_payload_size is coded and decoded. nn_payload_size indicates the number of bytes of nn_payload_byte.

byte_aliged( ) is a function that returns whether the current coded data is in bytes, and in a case of not being in bytes, the position of bits is adjusted by inserting a syntax element nn_alignment_zero_bit_b. The value of nn_alignment_zero_bit_b is always equal to 0.

nn_payload_byte [i] is coded and decoded as coded data of the generated image neural network of the number of bytes of nn_payload_size.

rbsp_trailing_bits( ) is a stuffing bit of 1 bit or more and 8 bits or less inserted so that the coded data of the RBSP structure is in byte units.

In the present embodiment, it has been shown that an image transmission system can be implemented using an image generation neural network.

### Second Embodiment

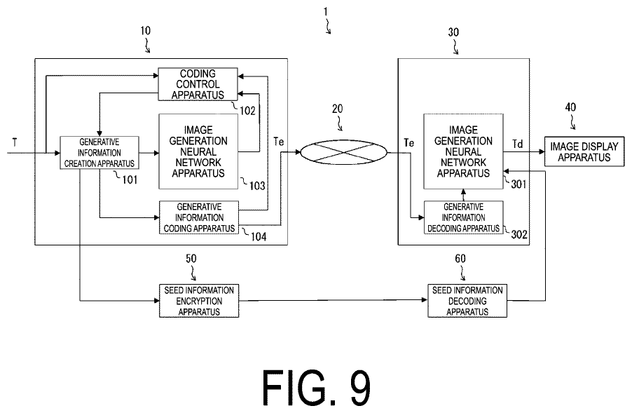

FIG. 9 is a conceptual diagram illustrating a configuration of another image transmission system according to the present embodiment.

In the image transmission system according to the present embodiment, seed information, which is a part of generative information, is separately encrypted, thereby increasing the confidentiality of coded data.

The image transmission system includes an image coding apparatus 10, a transmission network 20, an image decoding apparatus 30, an image display apparatus 40, a seed information encryption apparatus 50, and a seed information decryption apparatus 60.

The image coding apparatus 10 receives an input of an image signal T, and outputs coded data Te.

The transmission network 20 transmits the coded data Te from the image coding apparatus 10 to the image decoding apparatus 30. The transmission network 20 is the Internet, a Wide Area Network (WAN), a Local Area Network (LAN), or a combination thereof. The network 20 is not limited to a bi-directional communication network and may be a unidirectional communication network that transmits broadcast waves for terrestrial digital broadcasting, satellite broadcasting, or the like. The transmission network 20 may be substituted with a storage medium in which the coded data Te is recorded, such as a Digital Versatile Disc (DVD) (trade name) or a Blue-ray Disc (BD) (trade name).

The image decoding apparatus 30 receives an input of the coded data Te, outputs a decoded image Td, and sends the decoded image Td to the image display apparatus 40.

The image display apparatus 40 displays all or part of the decoded image Td output from the image decoding apparatus 30. For example, the image display apparatus 40 includes a display device such as a liquid crystal display and an organic Electro-luminescence (EL) display. Examples of display types include stationary, mobile, and HMD. In addition, in a case that the image decoding apparatus 30 has a high processing capability, an image having high image quality is displayed, and in a case that the apparatus has a lower processing capability, an image which does not require a high processing capability and display capability is displayed.

The image coding apparatus 10 includes a generative information creation apparatus 101, a coding control apparatus 102, an image generation neural network apparatus 103, and a generated image coding apparatus 104.

The generative information creation apparatus 101 receives the image signal T and a control signal from the coding control apparatus 102, creates generative information for image generation, and outputs the generative information to the image generation neural network apparatus 103 and the generative information coding apparatus 104. Furthermore, seed information of a part of the generative information is sent to the seed information encryption apparatus 50.

The image generation neural network apparatus 103 generates an image based on the generative information created by the generative information creation apparatus 101, and sends the image generation result to the coding control apparatus 102.

The generative information coding apparatus 104 codes the generative information and creates the coded data Te, and sends the code amount to the coding control apparatus 102.

The image decoding apparatus 30 includes an image generation neural network apparatus 301 and a generative information decoding apparatus 302.

The coding control apparatus 102 receives the image generation result of the image generation neural network apparatus 103, the image signal T, and the code amount of the generative information coding apparatus 104, and outputs a control signal to the generative information creation apparatus 101.

The seed information encryption apparatus 50 encrypts the seed information and transmits the encrypted seed information. At the same time, an encryption key (encrypted data) is sent to the seed information decryption apparatus 60 through a path different from the transmission network used for transmission of the prompt and the like. The encryption may be performed by using a common key system or a public key system. In the case of the common key system, the encryption key itself is transmitted, and in the case of the public key system, the encryption key is not transmitted, and the seed information encrypted with the public key corresponding to a secret key used by the seed information decryption apparatus 60 of the other party is transmitted. The seed information encrypted with the public key can be decrypted only by a device having a corresponding secret key. Note that the encrypted seed information itself may be transmitted through a path different from the transmission network.

Note that it is also possible to encrypt and decrypt only a part of the seed information, such as only seed_value in FIG. 5, without encrypting all of the seed information.

The generative information decoding apparatus 302 decodes the coded data Te based on the syntax, and sends the decoded generative information to the image generation neural network apparatus 301.

The seed information decryption apparatus 60 decrypts the encrypted seed information using the encrypted data, and sends the obtained seed information to the image generation neural network apparatus 301.

The image decoding apparatus 30 includes the image generation neural network apparatus 301 and the generative information decoding apparatus 302.

The image generation neural network apparatus 301 generates the decoded image Td based on the generative information decoded by the generative information decoding apparatus 302 and the seed information decryption apparatus 60, and sends the decoded image Td to the image display apparatus 40.

The generative information decoding apparatus 302 decodes the coded data Te based on the syntax, and sends the decoded generative information to the image generation network 301.

The image generation neural network apparatus 103 and the image generation neural network apparatus 301 perform the same operation.

In the present embodiment, seed information, which is a part of generative information, is encrypted, thereby increasing the confidentiality of coded data. In a state where the seed information is unknown, the image generation neural network apparatus 301 of the image decoding apparatus 30 cannot generate an accurate image.

Although seed information is encrypted in the present embodiment, text information or hint information may be encrypted and decrypted, and the same effect can be obtained.

### Third Embodiment

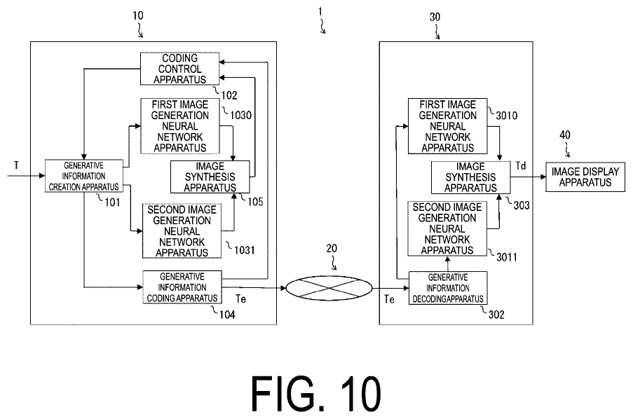

FIG. 10 is a conceptual diagram illustrating a configuration of another image transmission system according to the present embodiment.

The present embodiment is an image transmission system aiming at further improvement in performance by using a plurality of image generation neural networks.

Here, an example of a case where two image generation neural networks are used is shown.

The image transmission system includes an image coding apparatus 10, a transmission network 20, an image decoding apparatus 30, and an image display apparatus 40.

The image coding apparatus 10 receives an input of an image signal T, and outputs coded data Te.

The transmission network 20 transmits the coded data Te from the image coding apparatus 10 to the image decoding apparatus 30. The transmission network 20 is the Internet, a Wide Area Network (WAN), a Local Area Network (LAN), or a combination thereof. The network 20 is not limited to a bi-directional communication network and may be a unidirectional communication network that transmits broadcast waves for terrestrial digital broadcasting, satellite broadcasting, or the like. The transmission network 20 may be substituted with a storage medium in which the coded data Te is recorded, such as a Digital Versatile Disc (DVD) (trade name) or a Blue-ray Disc (BD) (trade name).

The image decoding apparatus 30 receives an input of the coded data Te, outputs a decoded image Td, and sends the decoded image Td to the image display apparatus 40.

The image display apparatus 40 displays all or part of the decoded image Td output from the image decoding apparatus 30. For example, the image display apparatus 40 includes a display device such as a liquid crystal display and an organic Electro-luminescence (EL) display. Examples of display types include stationary, mobile, and HMD. In addition, in a case that the image decoding apparatus 30 has a high processing capability, an image having high image quality is displayed, and in a case that the apparatus has a lower processing capability, an image which does not require a high processing capability and display capability is displayed.

The image coding apparatus 10 includes a generative information creation apparatus 101, a coding control apparatus 102, a first image generation neural network apparatus 1030, a second image generation neural network apparatus 1031, a generated image coding apparatus 104, and an image synthesis apparatus 105.

The generative information creation apparatus 101 receives the image signal T and a control signal from the coding control apparatus 102, creates generative information for image generation, and outputs the generative information to the first image generation neural network apparatus 1030, the second image generation neural network apparatus 1031, and the generative information coding apparatus 104.

The first image generation neural network apparatus 1030 and the second image generation neural network apparatus 1031 generate an image based on the generative information created by the generative information creation apparatus 101.

The image synthesis apparatus 105 synthesizes the two outputs and sends the image generation result to the coding control apparatus 102.

The generative information coding apparatus 104 codes the generative information and creates the coded data Te, and sends the code amount to the coding control apparatus 102.

The coding control apparatus 102 receives the image generation result of the image synthesis apparatus 105, the image signal T, and the code amount of the generative information coding apparatus 104, and outputs a control signal to the generative information creation apparatus 101. The image decoding apparatus 30 includes a first image generation neural network apparatus 3030, a second image generation neural network apparatus 3031, and a generative information decoding apparatus 302.

The generative information decoding apparatus 302 decodes the coded data Te based on the syntax, and sends the decoded generative information to the first image generation neural network apparatus 3030 and the second image generation neural network apparatus 3031. The generative information decoding apparatus 302 decodes background information and synthesized information in addition to seed information, hint information, and the like.

The first image generation neural network apparatus 3030 and the second image generation neural network apparatus 3031 generate an image based on the generative information decoded by the generative information decoding apparatus 302.

The image synthesis apparatus 105 synthesizes the two outputs to generate the decoded image Td, and sends the decoded image Td to the image display apparatus 40.

Note that the first image generation neural network apparatus 1030 and the first image generation neural network apparatus 3010 perform the same operation, and the second image generation neural network apparatus 1031 and the second image generation neural network apparatus 3011 perform the same operation.

The image synthesis apparatus 105 and an image synthesis apparatus 303 perform the same operation.

Although two image generation neural networks are illustrated in this example, two or more image generation neural networks may be used.

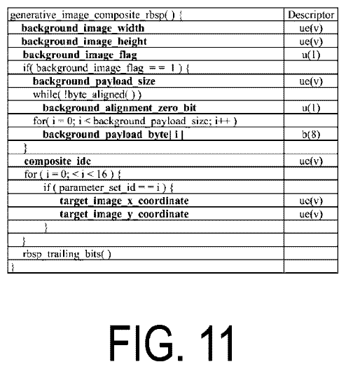

FIG. 11 illustrates an example of syntax in a case of synthesizing a plurality of generated images.

generative_image_composite_rbsp( ) is a syntax table of a raw byte sequence payload (RBSP) structure, and is coded data including an integer number of bytes encapsulated in the NAL unit.

The syntax element background_image_width is the number of pixels in the horizontal direction of the luminance of an image that is the background.

The syntax element background_image_height is the number of pixels in the vertical direction of the luminance of the image that is the background.

The syntax element background_image_flag is a flag indicating that the background image is coded and decoded as coded data different from the generated image.

In a case that the value of background_image_flag is 1, a background image is present, and the syntax element background_payload_size is coded and decoded. background_payload_size indicates the number of bytes of background_payload_byte.

byte_aliged( ) is a function that returns whether the current coded data is in bytes, and in a case of not being in bytes, the position of bits is adjusted by inserting a syntax element background_alignment_zero_bit. The value of background_alignment_zero_bit is always equal to 0.

background_payload_byte [i] is coded and decoded as coded data of the background image of the number of bytes of background_payload_size.

The background image is coded and decoded by an existing image coding scheme, such as JPEG, JPEG2000, AVC, HEVC, VVC, PNG, or the like.

The syntax element composite_idc is mode information indicating how to synthesize the generated image. In a case that the value is 0, it indicates that the average value of the generated images, excluding the background image, is overwritten on the generated images, in a case that the value is 1, it indicates that the background image is overwritten with a generated image having a large value of parameter_set_id, and in a case that the value is 2, it indicates that the background image is overwritten with a generated image having a small value of parameter_set_id. In a case that the generated image includes an alpha map or in a case that an alpha map is coded and decoded as hint information, the background and the generated image may be synthesized using the value of the alpha map (information of pixel transparency) as a weighting factor.

In addition, in a case that the depth map is coded and decoded by the hint information, the generated image may be synthesized based on the depth information of the generated image.

The syntax element target_image_x_coordinate represents a pixel position in the horizontal direction from the upper left edge of the background image, and the syntax element target_image_y_coordinate represents a pixel position in the vertical direction from the upper left edge of the background image. Then, the generated image with parameter_set_id of i is placed with the upper left edge thereof aligned with the upper left edge of the background image.

Note that in a case that the processing described above is performed, chroma_format_idc and bitdepth_minus8 of all generated images are required to be the same.

rbsp_trailing_bits( ) is a stuffing bit of 1 bit or more and 8 bits or less inserted so that the coded data of the RBSP structure is in byte units.

In the present embodiment, the performance can be further improved by synthesizing the image generation of the plurality of image generation neural networks.

Note that a part or all of the image coding apparatus 10 and the image decoding apparatus 30 in the above-described first, second, and third embodiments may be implemented by a computer. In that case, this configuration may be implemented by recording a program for implementing such control functions on a computer-readable recording medium and causing a computer system to read and perform the program recorded on the recording medium. Note that the “computer system” mentioned here refers to a computer system built into either the image coding apparatus 10 or the image decoding apparatus 30 and is assumed to include an OS and hardware components such as a peripheral apparatus. In addition, the “computer-readable recording medium” refers to a portable medium such as a flexible disk, a magneto-optical disk, a ROM, and a CD-ROM, and a storage apparatus such as a hard disk built into the computer system. Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a certain period of time, such as a volatile memory included in the computer system functioning as a server or a client in such a case. In addition, the above-described program may be one for implementing some of the above-described functions, and also may be one capable of implementing the above-described functions in combination with a program already recorded in a computer system.

In addition, a part or all of the image coding apparatus 10 and the image decoding apparatus 30 in the embodiments described above may be implemented as an integrated circuit such as a Large Scale Integration (LSI). Function blocks of the image coding apparatus 10 and the image decoding apparatus 30 may be individually implemented as processors, or some or all of the function blocks may be integrated into processors. In addition, the circuit integration technique is not limited to LSI, and implementation as a dedicated circuit or a general-purpose processor may be adopted. In addition, in a case that a circuit integration technology that replaces LSI appears as the semiconductor technologies advance, an integrated circuit based on that technology may be used.

Although an embodiment of the present invention has been described above in detail with reference to the drawings, the specific configurations thereof are not limited to those described above and various design changes or the like can be made without departing from the spirit of the invention.

An embodiment of the present invention is not limited to the embodiments described above and various changes can be made within the scope indicated by the claims. That is, embodiments obtained by combining technical measures appropriately modified within the scope indicated by the claims are also included in the technical scope of the present invention.

### INDUSTRIAL APPLICABILITY

The embodiments of the present invention can be preferably applied to an image decoding apparatus that decodes coded data in which image data is coded, and an image coding apparatus that generates coded data in which image data is coded. The embodiments of the present invention can be preferably applied to a data structure of coded data generated by the image coding apparatus and referred to by the image decoding apparatus.

### Cross-Reference of Related Application

The present application claims priority of JP 2023-144898, filed on Sep. 7, 2023, and all the contents thereof are included herein by the reference.

### REFERENCE SIGNS LIST

1 Image transmission system
10 Image coding apparatus
20 Transmission network
30 Image decoding apparatus
101 Generative information creation apparatus
102 Coding control apparatus
103, 301 Image generation neural network apparatus
1030, 3010 First image generation neural network apparatus
1031, 3011 Second image generation neural network apparatus
104 Generative information coding apparatus
1041 Image information coder
1042 Text information coder
1043 Seed information coder
1044 Hint information coder
1045 Image generation neural network coder
105 Image synthesis apparatus
302 Generative information decoding apparatus
3021 Image information decoder
3022 Text information decoder
3023 Seed information decoder
3024 Hint information decoder
3025 Image generation neural network decoder
40 Image display apparatus
50 Seed information encryption apparatus
60 Seed information decryption apparatus

1-7. (canceled)

8. An image decoding apparatus of decoding coded date, the image decoding apparatus comprising:
an image generation neural network circuit that decodes generative information including text information from the coded date, and generates an image based on the generative information; wherein
the text information includes:
a first syntax element indicating a prompt string for a neural network and
a second syntax element having a value of 0 in a case that the coded data is not byte aligned, and
the second syntax element is followed by the first syntax element.

9. The image decoding apparatus of claim 8, further comprising:
a seed information decoding circuit that decodes seed information from the coded data, wherein the seed information is a seed value used as input for the neural network.

10. An image coding apparatus of coding image date, the image coding apparatus comprising:
an image generation neural network circuit that codes generative information including text information, and generates an image based on the generative information;
wherein
the text information includes:
a first syntax element indicating a prompt string for a neural network and
a second syntax element having a value of 0 in a case that the coded data is not byte aligned, and
the second syntax element is followed by the first syntax element.

11. A method of generating an image, the method including:
generates the image based on generative information, wherein the generative information includes text information; wherein
the text information includes:
a first syntax element indicating a prompt string for a neural network and
a second syntax element having a value of 0 in a case that the image is not byte aligned, and
the second syntax element is followed by the first syntax element.
